(19) United States
(12) Patent Application Publication
(10) Pub. No.: US 2013/0126353 A1
(43) Pub. Date: May 23, 2013

(54) ELECTRODIALYSIS WITH ION EXCHANGE AND BI-POLAR ELECTRODIALYSIS

(71) Applicants: Brent Gerard PEREZ, Minnetonka, MN (US); Bruce T. BATCHELDER, Burlington, MA (US); William Thomas HARVEY, Burlington, MA (US); William Daniel MCCLAIN, Phoenix, AZ (US); Kenneth J. IRWIN, Moorestown, NJ (US); Jamie Paul VINSANT, Burlington, MA (US)

(72) Inventors: Brent Gerard PEREZ, Minnetonka, MN (US); Bruce T. BATCHELDER, Burlington, MA (US); William Thomas HARVEY, Burlington, MA (US); William Daniel MCCLAIN, Phoenix, AZ (US); Kenneth J. IRWIN, Moorestown, NJ (US); Jamie Paul VINSANT, Burlington, MA (US)

(73) Assignee: GENERAL ELECTRIC COMPANY, Schenectady, NY (US)

(21) Appl. No.: 13/298,860

(22) Filed: Nov. 17, 2011

(51) Int. Cl. C02F 1/469; C25B 9/08

(52) U.S. Cl. 204/520; 204/631

(57) ABSTRACT

In a water treatment system described in this specification, an ED device (which may be an EDR device) is combined with an ion exchange unit and a bipolar electrodialysis (BPED) device. The ion exchange unit, for example a weak acid cation exchange unit, is placed upstream of the ED device and removes divalent cations from the feed water to the ED device. The BPED device receives the salt-concentrated solution from the ED device and produces a regenerating solution. This regenerating solution is used to recharge the ion exchange unit when required. The regenerating solution may be an acidic solution.

### FIELD

The present disclosure relates to a system and process for treating water using electrodialysis.

### BACKGROUND

Electrodialysis (ED) is a water treatment method which uses an applied electric potential difference to transport ions from one solution, through ion exchange membranes, to another solution. For example, in desalination the applied electric potential difference is used to move the salt ions from a feed solution to a salt-concentrated solution, thereby reducing the salt concentration in the feed solution. The feed solution may be, for example, well water, brackish surface water, partially desalinated seawater, or wastewater being treated for reclamation.

ED is typically performed using an electrodialysis stack. An electrodialysis stack includes alternating anion and cation exchange membranes placed between two electrodes. The feed solution flows in between alternating pairs of the anion and cation exchange membranes. The applied electric potential difference: (1) moves cations through the cation exchange membrane, towards the cathode; and (2) moves anions through the anion exchange membrane, towards the anode, into the salt-concentrated solution. The anions and cations become trapped between an adjacent set of alternating pairs of the anion and cation exchange membranes to produce the salt-concentrated solution. The applied electric potential difference thereby allows the salt-concentrated solution to be concentrated with the cations and anions from the feed solution, and the feed solution to be reduced in cation and anion concentration. In this manner, the electrodialysis stack delivers a desalinated effluent.

ED equipment is prone to scaling. Due to polarization phenomena, the concentration of ions in the salt-concentrated solution is particularly high directly against the membrane surfaces. The passage of the current also causes acid-base generation in the salt-concentrated solution which creates an alkaline environment at the interface between the anion exchange membrane and the salt-concentrated solution. This environment encourages precipitation of calcium carbonate and magnesium hydroxide scales. Scales of barium and strontium sulfates, for example, have also been observed. Additional reactions at the anode and cathode also tend to cause scaling.

Scaling is addressed in ED equipment firstly with the use of flow channel spacers. Besides separating the membranes, with adequate flow velocity the flow channel spacers cause turbulence which reduces ion polarization at the membrane surfaces. Some polarization, however, continues. A second technique is the use of an electrodialysis reversal (EDR) process, wherein the current direction and liquid flows are reversed periodically. EDR units are less prone to scaling that ordinary ED equipment, enough to justify their increased complexity and expense in many applications, but even EDR units still experience scaling problems. Another approach is to inject an acid, for example sulfuric acid, or a specialty de-scalant chemical into the ED device. The chemicals, however, have a cost and acids may corrode parts of the ED equipment. Further, large amounts of acid are required to prevent scaling in the concentrated and buffered solutions within an ED device. Yet another approach is to pre-treat the feed water to soften it. Softening, however, requires a chemical input such as lime or an ion-exchange regenerating chemical.

Despite the techniques described above, scaling remains a problem in ED processes. Scales increase the resistance of the stack resulting in decreased electrical efficiency. The threat of scaling causes manufacturers to limit the current density, which results in the stack having to be larger. The threat of scaling also causes operators to limit the extent to which they concentrate the salt-concentrated solution, which results in more feedwater being used, and more wastewater being generated, for the same product output.

### INTRODUCTION TO THE INVENTION

The following discussion is intended to introduce the reader to the detailed discussion to follow, and not to limit any claimed invention. A claimed invention may relate to a sub-combination of elements or steps described below, or to a combination of one or more elements or steps described below with an element or step described in other parts of this specification.

In a water treatment system described in this specification, an ED device (which may be an EDR device) is combined with an ion exchange unit and a bipolar electrodialysis (BPED) device. The ion exchange unit, for example a weak acid cation exchange unit, is placed upstream of the ED device and removes divalent cations from the feedwater to the ED device. The ED device treats this feed water to produce a desalinated effluent and a salt-concentrated solution. The BPED device receives the salt-concentrated solution from the ED device and produces a regenerating solution. This regenerating solution is used to recharge the ion exchange unit when required.

Without limiting the invention to any particular theory of operation or benefit, the inventors believe that the system described above, and the treatment process that it implements, provides a synergistic combination of its major components. Since the ion exchange unit removes divalent cations from the feed water to the ED device, the concentration of divalent cations in the salt-concentrated solution and electrode chambers within the ED device is also reduced. Scaling is primarily caused by divalent cations, and so scaling is reduced. However, a primary disadvantage of ion exchange softening, namely to need to consume a chemical regenerant, is avoided or reduced by regenerating the ion exchange device with regenerating BPED solution. This regenerating BPED solution is in turn created from the salt-concentrated solution from the ED device, which is normally considered to be a waste stream. Accordingly, this waste stream is reduced and re-used and avoids the need to purchase, store and consume chemicals brought in from outside of the system. The regenerating BPED solution may be an acidic solution.

### BRIEF DESCRIPTION OF THE DRAWINGS

FIG. 1 is a schematic illustrating a water treatment system that includes an ion exchange system, an electrodialysis-based desalination system, and a bipolar electrodialysis system.

FIG. 2 is a schematic illustrating a water treatment system that includes an ion exchange system, an electrodialysis-based desalination system, a bipolar electrodialysis system, and bypasses that divert flow around components of the system.

FIG. 3 is an illustration of an electrodialysis stack.

FIG. 4 is an illustration of a three compartment bipolar electrodialysis cell.

FIG. 5 is an illustration of a two compartment bipolar electrodialysis cell with anion exchange membranes.

### DETAILED DESCRIPTION

Generally, the present disclosure provides a method and system for desalinating an aqueous solution using electrodialysis where the system includes components which advantageously use a waste product from one component of the system as the desired starting material for another component of the system.

The desalination system includes: an ion exchange device adapted to receive a feed water to be treated and to produce a multi-valent cation depleted solution; an electrodialysis device adapted to receive the multi-valent cation depleted solution and to produce a desalinated effluent and a salt-concentrated solution; a bipolar electrodialysis device adapted to receive the salt-concentrated solution and to produce an acid solution; and, an ion exchange regeneration system adapted to flow the acid solution through the ion exchange device.

In some examples of the system, the components of the system and the processes that they implement use only a sufficient amount of starting material to generate an amount of waste product which is sufficient for the starting material requirements of the subsequent component.

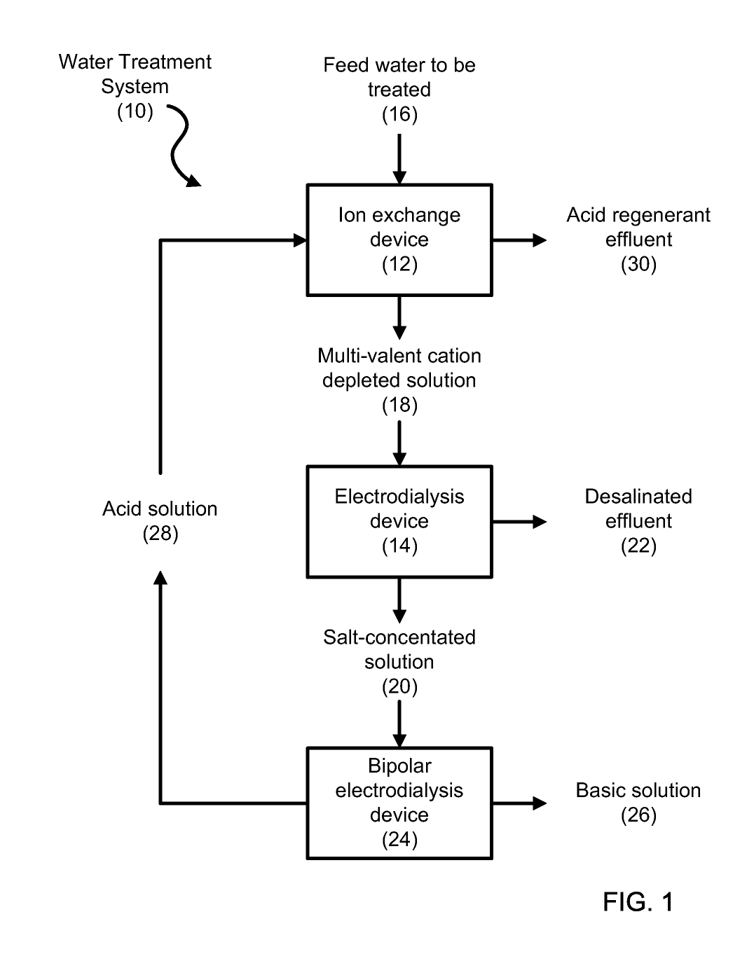

An example of a water treatment system according to the disclosure is illustrated in FIG. 1. The water treatment system (10) includes an ion exchange device (12);

and an electrodialysis device (14). The ion exchange device (12) accepts a feed water to be treated (16) and provides multi-valent cation depleted solution (18), which is accepted by the electrolysis device (14). The multi-valent cation depleted solution (18) is reduced in ions which are detrimental to the functioning of the electrodialysis device (14). The electrolysis device (14) provides a salt-concentrated solution (20) and a desalinated effluent (22).

The water treatment system (10) of the current application also includes a bipolar electrodialysis device (24). The bipolar electrodialysis device (24) accepts the salt-concentrated solution (20) and provides a basic solution (26) and an acid solution (28). The acid solution (28) is used to regenerate, when necessary, depleted ion exchangers in the ion exchange device (12) using an ion exchange regeneration system within the ion exchange device (12) adapted to flow the acid solution (28) through the ion exchange device.

The ion exchange device (12) accepts the regenerating acid solution (28) using the ion exchange regenerating system and the acid displaces ions which were removed from the feed water (16). The displaced ions are removed and discharged by the ion exchange device (12) in acid regenerant effluent (30). In this manner, the ion exchangers are regenerated with acid and again available to remove an ion in the feed water (16) and replace that ion with an ion, for example hydronium ion, from the ion exchanger.

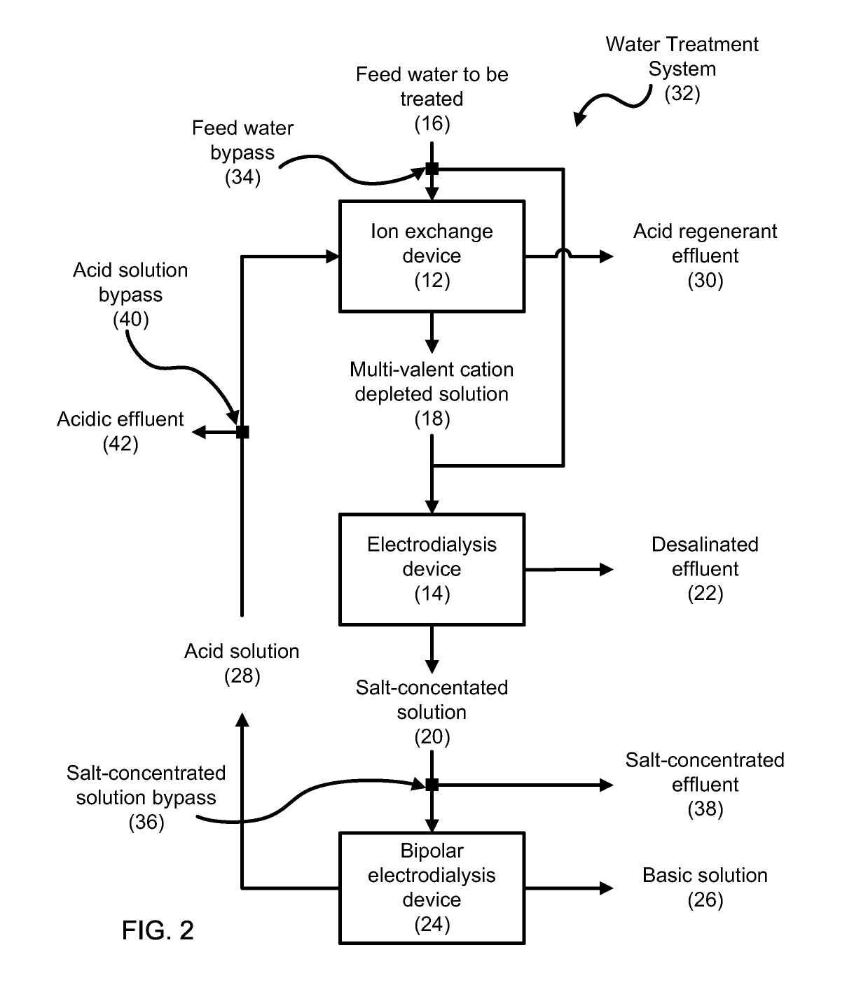

In addition to the components discussed above with respect to the system illustrated in FIG. 1, a water treatment system (32), illustrated in FIG. 2, may include at least one bypass to divert at least a portion of an input stream away from a component. For example, a bypass may divert: feed water to be treated around the ion exchange device (12), salt-concentrated solution away from the bipolar electrodialysis device (24), or acid solution away from the ion exchange device (12). The water treatment system (32) is shown with three bypasses, though a system according to the disclosure could alternatively include one or two bypasses. Other water treatment systems according to the application could include more than three bypasses.

Water treatment system (32) accepts feed water to be treated (16). If the feed water (16) will not promote scaling in the electrodialysis device (14), for example because the concentration of multi-valent cations in the feed water is below a desired threshold, the feed water (16) may be diverted around the ion exchange device (12) using feed water bypass (34). If the concentration of multi-valent cations is above the desired threshold, a portion of the feed water (16) may be treated in the ion exchange device (12) while the remaining portion of the feed water (16) is diverted around the ion exchange device (12). The amount of the feed water treated in the ion exchange device is selected so that sufficient multi-valent cations are removed to bring the final concentration of multi-valent cations in the combined diverted and undiverted portions below the desired threshold.

Diverting all or a portion of the feed water (16) around the ion exchange device (12), and treating only enough feed water to bring the final concentration of multi-valent cations in the combined diverted and undiverted portions below the desired threshold, may reduce scaling in the electrodialysis device and reduce the operational and maintenance costs associated with the ion exchange device (12) and the amount of acid solution (28) required.

The bipolar electrodialysis device (24) accepts salt-concentrated solution (20). If a sufficient amount of acid solution (28) has already been produced, for example if there is enough acid solution to regenerate depleted ion exchangers in the ion exchange device (12), then all of the salt-concentrated solution (20) may be diverted away from the bipolar electrodialysis device (24) using a salt-concentrated solution bypass (36), thereby producing salt-concentrated solution (38). Using the salt-concentrated solution bypass (36) in this manner, the water treatment system (32) may avoid costs associated with running and maintaining the bipolar electrodialysis device (24).

Alternatively, the rate of production of acid solution (28) may be modulated by diverting a portion of the salt-concentrated solution (20) away from the bipolar electrodialysis device (24) using the salt-concentrated solution bypass (36), thereby producing the salt-concentrated solution (38) while at the same time providing the salt-concentrated solution (20) to the bipolar electrodialysis device (24). In this manner, the acid solution (28) may be produced at a rate which is equal to the rate the acid solution (28) is used in the ion exchange device (12) to regenerate the ion exchangers.

The ion exchange device (12) accepts acid solution (28). If a sufficient amount of acid solution (28) has been accepted by the ion exchange device (12), for example if the ion exchangers have been recently regenerated, then all of the acid solution (28) may be diverted away from the ion exchange device (12) using acid solution diverter (40), thereby producing acidic effluent (42). This may be desirable in situations where there is an unmet commercial desire for the acidic effluent (42) that compensates for the maintenance and operational costs associated with running the bipolar electrodialysis device (24).

Alternatively, the flow rate of the acid solution (28) in to the ion exchange device may be modulated by diverting a portion of the acid solution (28) away from the ion exchange device (12) using the acid solution bypass (40), thereby producing the acid effluent (42) while at the same time providing the acid solution (28) to the ion exchange device (12). In this manner, the rate of acid consumption used in the regeneration of the ion exchangers may be equal to the rate of displacement of the multi-valent cations from the ion exchangers. In this manner, the acid regenerant effluent (30) may be neutral or mildly acidic since substantially all of the acid is used to regenerate the ion exchangers.

The three bypasses may be used in any combination to optimize the operation of the system depending on such factors as, for example, operational and maintenance costs of the individual components, commercial desire for the effluent produced by the individual components, or disposal costs of the effluents produced by the individual components.

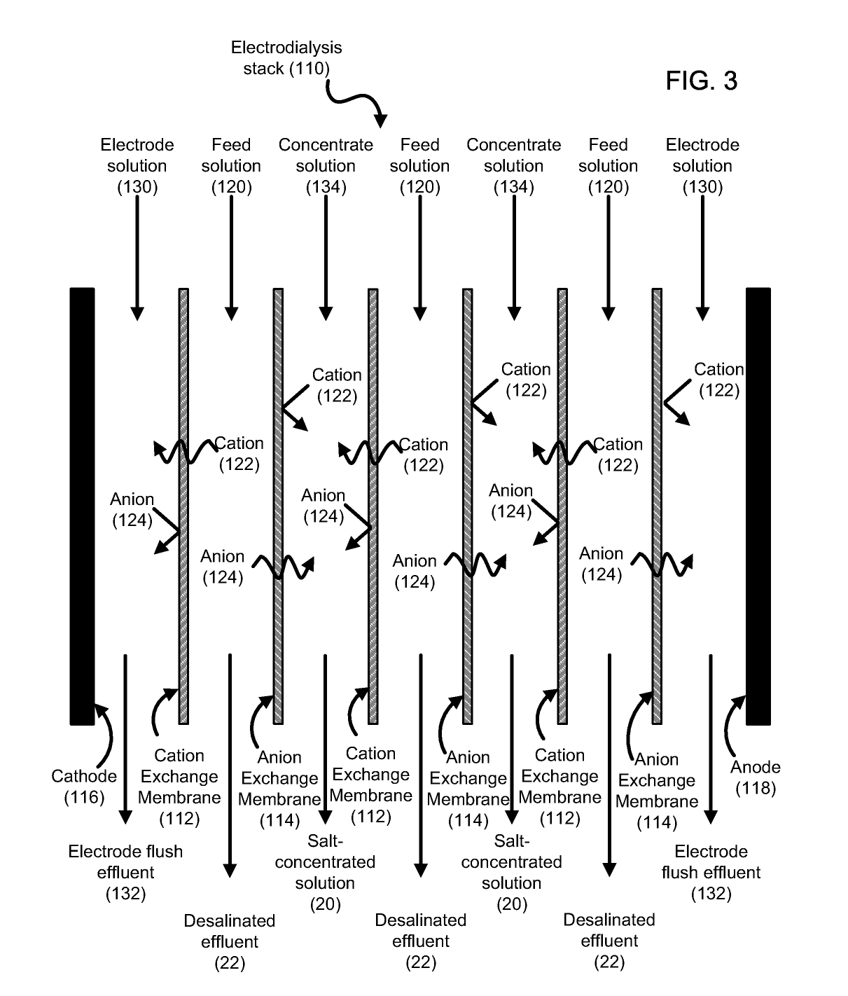

The electrodialysis device (14) includes an electrodialysis stack which performs the electrodialysis. An illustration of an electrodialysis stack (110) is shown in FIG. 3. The electrodialysis stack (110) includes alternating cation and anion exchange membranes (112 and 114, respectively) placed between a cathode (116) and an anode (118). An electrodialysis feed solution (120) flows in between the alternating pairs of the anion and cation exchange membranes (112 and 114) and the applied electric potential difference: (1) moves cations (122) through the cation exchange membrane (112), towards the cathode; and (2) moves anions (124) through the anion exchange membrane (114), towards the anode. The cations and anions are concentrated into the salt-concentrated solution (20) dispensed by the electrodialysis device (14). The electrodialysis feed solution (120) would be understood to be the feed water to be treated (16), the multi-valent cation depleted solution (18), or any mixture of the two, along with any recirculated desalinated effluent (22).

The applied electric potential difference allows the salt-concentrated solution (20) to be concentrated with the cations (122) and anions (124) from the feed solution (120), and the feed solution (120) to be reduced in cation (122) and anion (124) concentration. In this manner, the electrodialysis stack delivers a desalinated effluent (22).

In order to carry the current across the electrodialysis stack (110), electrode solution (130) is provided which flows past the cathode (116) and the anode (118). The electrode solution (130) includes ions to carry the current, and is not shown in FIG. 1 or 2. The electrode solution (130) may be of the same composition as the feed solution (120), or may be of a different composition from the feed solutions. The electrode solution (130) is delivered from the electrodialysis stack as electrode flush effluent (132), not shown in FIG. 1 or 2.

In addition, there is provided to the electrodialysis stack (110) a concentrate solution (134) which flows between pairs of cation exchange membranes (112) and anion exchange membranes (114). The concentrate solution (134) may initially be the same as the feed solution (120). The ions in the feed solution flow through the ion exchange membranes and into the concentrate solution (132) to produce the salt-concentrated solution (20), which is dispensed from the electrodialysis stack (110).

The electrodialysis stack (110) may operate in a number of different configurations. For example, the electrodialysis stack (110) may: accept the electrodialysis feed solution (120) on a continuous basis, thereby operating as a continuous process; accept a batch of solution of electrodialysis feed solution (120) and circulate the batch of solution through the electrodialysis stack (110), thereby operating as a batch process; or accept the electrodialysis feed solution (120) on a continuous basis but circulate the solution through the electrodialysis stack (110), thereby operating as a feed-and-bleed process. The current and flows in the electrodialysis stack (110) may be reversed periodically as in the known EDR process.

Bipolar membrane electrodialysis (or, bipolar electrodialysis) is a process that couples electrolysis and electrodialysis, accepting a salt solution and providing an acidic solution and a basic solution. A bipolar membrane electrodialysis cell may be a two or three compartment cell, depending on the acid and base to be produced.

A two compartment cell may include bipolar membranes and either cation exchange membranes or anion exchange membranes. Two compartment cells that include bipolar membranes and cation exchange membranes are useful to convert the salts of strong bases and weak acids, such as, for example, sodium acetate, lactate, formate, glycinate, and other organic and amino acids. In contrast, two compartment cells that include bipolar membranes and anion exchange membranes are useful to convert the salts of strong acids and weak bases, such as, for example, ammonium chloride, ammonium sulfate, and ammonium lactate. In three compartment cells it is possible to convert an aqueous salt solution into the strong bases and strong acids, such as, for example, the conversion of NaCl into NaOH and HCl. Other salts, for example KF, Na₂SO₄, NH₄Cl, KCl, as well as the salts of organic acids and bases, can also be converted using three compartment cells.

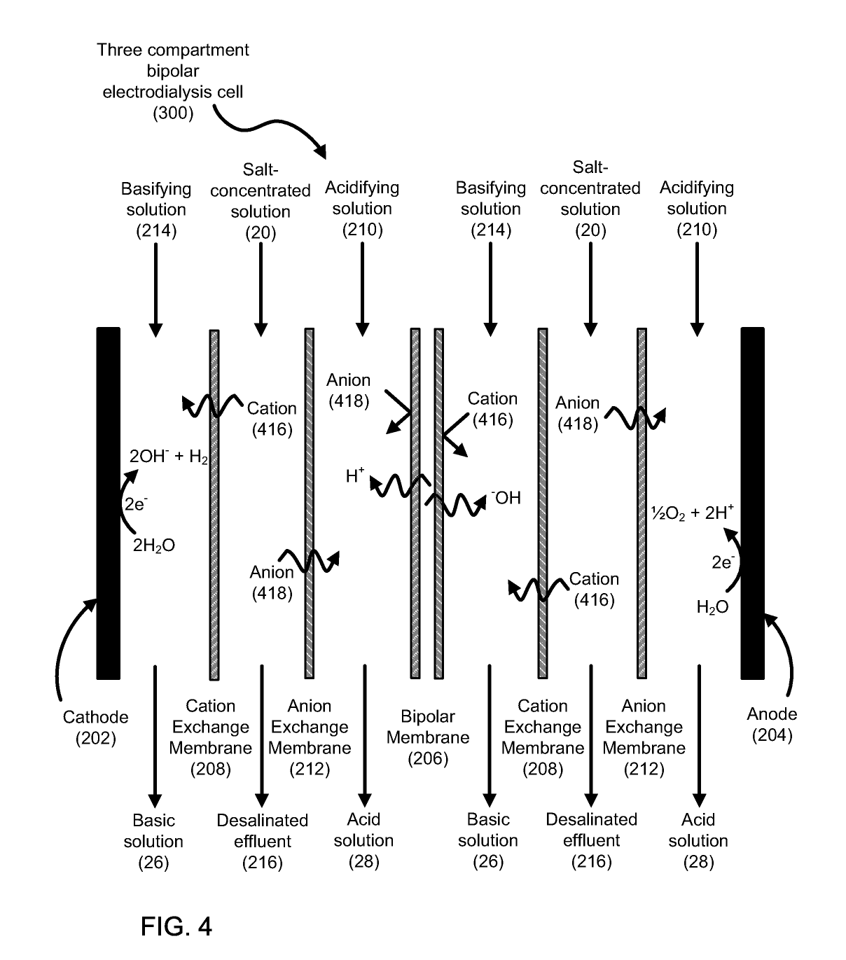

An illustration of a three compartment bipolar electrodialysis cell (200), which may be used in a water treatment system according to the present disclosure, is shown in FIG. 4.

The bipolar electrodialysis cell (200) illustrates a single cell between cathode (202) and anode (204), though it would be understood that multiple cells could be installed in a bipolar electrodialysis stack. Using electrolysis, bipolar electrodialysis disassociates water, which is found between a cation exchange membrane portion and an anion exchange membrane portion of the bipolar membrane (206), into H⁺ and ⁻OH. Application of an applied electric potential difference induces the produced H⁺ ions to move towards the cathode (202), through cation exchange membranes (208), into an acidifying solution (210). Similarly, the produced ⁻OH ions to move towards the anode (204), through anion exchange membranes (212), into a basifying solution (214). In a similar manner, cations (416) and anions (418) in the salt solution (20) are induced to move through the cation and anion exchange membranes, respectively, as charge balance for the H⁺ and ⁻OH ions, resulting in desalinated effluent (216) being discharged from the cell (200).

With acceptance of the H⁺ ions, the acidifying solution (210) becomes acidic and is discharged from the bipolar electrodialysis cell (200) as the acid solution (28). Conversely, with acceptance of the ⁻OH ions, the basifying solution (214) becomes basic and is discharged from the bipolar electrodialysis cell (200) as the basic solution (26).

The acidifying solution (210) and the basifying solution (214) include ions to carry the applied current. These ions become the counter-ions of in the produced acids and bases. The acidifying solution (210), the basifying solution (214) and the salt-concentrated solution (20) may all be the same or different.

In one example, the acidifying solution, the basifying solution and the salt-concentrated solution are all NaCl/water solutions, where the resulting acid solution is an HCl/water solution and the resulting basic solution is an NaOH/water solution. In another example, the acidifying solution, the basifying solution and the salt-concentrated solution are all sodium sulfate/water solutions, where the resulting acid solution is an H₂SO₄/water solution and the resulting basic solution is an NaOH/water solution. In yet another example, the acidifying solution, the basifying solution and the salt-concentrated solution are all mixtures of different salts, such as sodium sulfate and NaCl, and the resulting acid solution is an H₂SO₄/HCl/water solution and the resulting basic solution is an NaOH/water solution.

In still another example, the acidifying solution and the basifying solution are water, while the salt-concentrated solution is a NaCl/water solution, where the resulting acid solution is an HCl/water solution and the resulting basic solution is an NaOH/water solution.

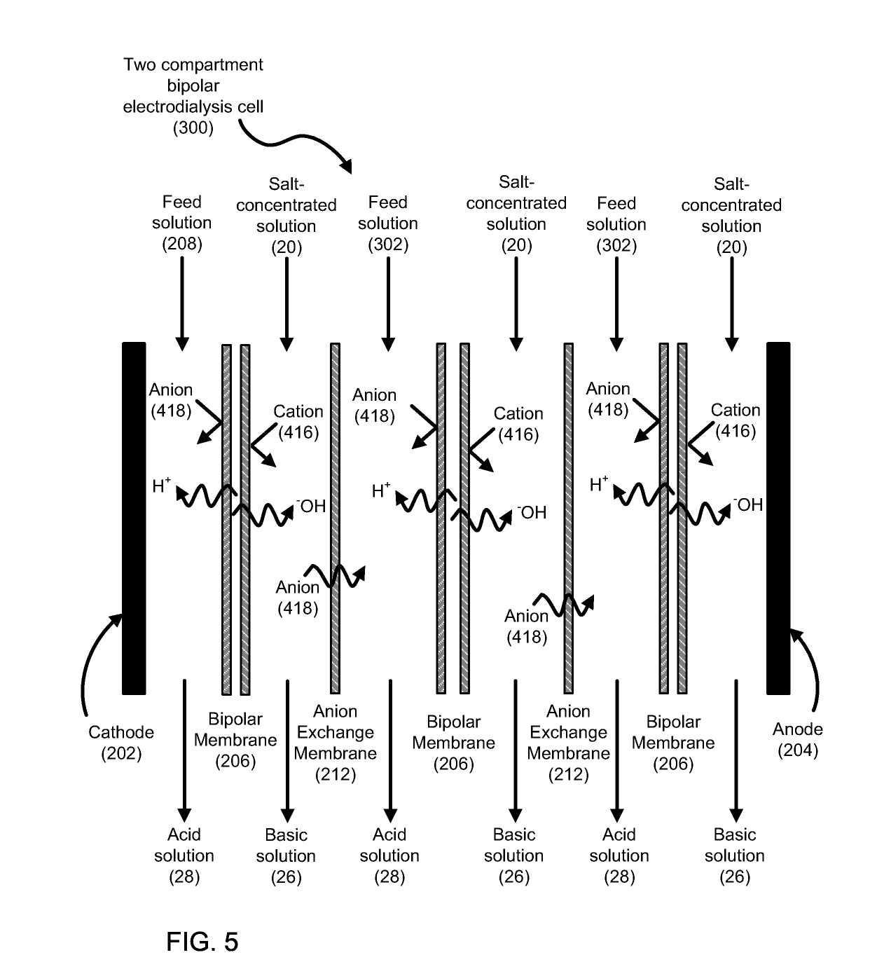

Although a three compartment bipolar electrodialysis cell is illustrated in FIG. 4, a water treatment system according to the present application may alternatively include a two compartment bipolar electrodialysis cell with anion exchange membranes, or a two compartment bipolar electrodialysis cell with cation exchange membranes, depending on the acid and base to be produced. An illustration of a two compartment bipolar electrodialysis cell (300) with anion exchange membranes is shown in FIG. 5.

The bipolar electrodialysis cell (300) illustrates a single cell between cathode (202) and anode (204), though it would be understood that multiple cells could be installed in a bipolar electrodialysis stack. Using electrolysis, bipolar electrodialysis disassociates water, which is found between a cation exchange membrane portion and an anion exchange membrane portion of the bipolar membrane (206), into H⁺ and ⁻OH. Application of an applied electric potential difference induces the produced H⁺ ions to move towards the cathode (202) into a feed solution (302), and the produced ⁻OH ions to move towards the anode (204) into the salt-concentrated solution (20). The bipolar electrodialysis cell (300) includes anion exchange membranes (212).

With acceptance of the H⁺ ions, the feed water solution (302) becomes acidic and is discharged from the bipolar electrodialysis cell (300) as the acid solution (28). Conversely, with acceptance of the ⁻OH ions, the salt-concentrated solution (20) becomes basic and is discharged from the bipolar electrodialysis cell (300) as the basic solution (26).

The feed solution (302) and the salt-concentrated solution (20) include ions to carry the applied current. These ions become the counter-ions of in the produced acids and bases. The feed solution (302) and the salt-concentrated solution (20) may be the same or different.

Ion exchangers are used for separation, purification, and decontamination processes. Ion exchangers are able to remove an ion in a feed solution and replace that ion with an ion from the ion exchanger. Ion exchangers may be, for example, resins, microporous minerals, such as zeolites, or clays. Resin-based ion exchangers (also called “ion exchange resins”) may be made from polymers which have functional groups that are able to exchange the ionically-bound ion with the ion in the feed solution.

With use, the ions originally found in the ion exchanger are replaced with the ions from the feed solution, and it is desirable to regenerate the ion exchanger. Regeneration of the ion exchanger may be accomplished by replacing the ions which were removed from the feed solution with desired ions, such as by washing the ion exchanger with an excess of the desired ions, or under conditions which displace the ions which were removed from the feed solution from the ion exchanger.

Ion exchangers according to the current application, used in the ion exchange device (12), remove multi-valent cations from the feed water to be treated and provide the multi-valent cation depleted solution (18). Although the following discussion refers to resin based ion exchangers, non-resin based ion exchangers could also be used as long as they removed multi-valent cations from the feed water to be treated in order to provide the multi-valent cation depleted solution (18).

In a particular example, the ion exchanger is a resin, and removes calcium (Ca²⁺), magnesium (Mg²⁺), or both, from water and replaces the cations with H⁺. With use, these ion exchange resins become depleted of H⁺ ions and accumulate calcium ions, magnesium ions, or both. The calcium ions, magnesium ions, or both may be removed from the ion exchange resin by washing the resin with, for example, a solution having a high concentration of H⁺ (for example, an HCl solution).

As illustrated in FIGS. 1 and 2, an ion exchange device (12) accepts the feed water to be treated (16) and provides the multi-valent cation depleted solution (18). The ion exchange device (12) may operate in a number of different configurations. For example, the ion exchange device (12) may: accept the feed water to be treated (16) on a continuous basis, thereby operating as a continuous process; accept a batch of feed water to be treated (16) and circulate the batch through the ion exchanger (12), thereby operating as a batch process; or accept the feed water to be treated (16) on a continuous basis but circulate the feed water through the ion exchanger (12), thereby operating as a feed-and-bleed process.

It is desirable to use the multi-valent cation depleted solution (18) as the feed solution for the electrodialysis device (14) since the multi-valent cation depleted solution (18) is reduced in ions which may cause scaling and, therefore, are detrimental to the operation of the electrodialysis device (14). For example, the ion exchange device (12) may remove calcium (Ca²⁺), magnesium (Mg²⁺), or both, from water and replace the calcium, magnesium, or both, with H. It is desirable to use the resulting multi-valent cation deleted solution in the electrodialysis device (14) since the introduced H⁺ ions do not precipitate in the electrodialysis device (14).

This written description uses examples to help disclose the invention, including the best mode, and also to enable any person skilled in the art to practice the invention, including making and using any devices or systems and performing any incorporated methods. Alterations, modifications and variations can be effected to the particular examples by those of skill in the art without departing from the scope of the invention. The patentable scope of the invention is defined by the claims, and may include other examples that occur to those skilled in the art.

What is claimed is:

1. A water treatment system comprising:
an ion exchange device adapted to receive a feed water to be treated and to produce a multi-valent cation depleted solution;
an electrodialysis device adapted to receive the multi-valent cation depleted solution and to produce a desalinated effluent and a salt-concentrated solution;
a bipolar electrodialysis device adapted to receive the salt-concentrated solution and to produce a regenerating solution; and,
an ion exchange regeneration system adapted to flow the regenerating solution through the ion exchange device.

2. The water treatment system according to claim 1, wherein the regenerating solution is an acid solution.

3. The water treatment system according to claim 1, further comprising a feed water bypass that diverts the feed water to be treated around the ion exchange device.

4. The water treatment system according to claim 1, further comprising a salt-concentrated solution bypass that diverts the salt-concentrated solution away from the bipolar electrodialysis device.

5. The water treatment system according to claim 1, further comprising an acid solution bypass that diverts the acid solution away from the ion exchange device.

6. The water treatment system according to claim 1, wherein the multi-valent cations are calcium cations, barium cations, strontium cations, iron cations, manganese cations, magnesium cations, or any combination thereof.

7. The water treatment system according to claim 1, wherein the system is a continuous system, a batch system, or a feed-and-bleed system.

8. The water treatment system according to claim 1, wherein the bipolar electrodialysis device is a two-compartment bipolar electrodialysis device having anion exchange membrane.

9. The water treatment system according to claim 1, wherein the bipolar electrodialysis device is a two-compartment bipolar electrodialysis device having cation exchange membrane.

10. The water treatment system according to claim 1, wherein the bipolar electrodialysis device is a three-compartment bipolar electrodialysis device.

11. A method for treating water comprising the steps of:
removing multi-valent cations from a feed stream to an ion exchange media to produce a multi-valent cation depleted solution;
applying an electric potential difference across the multi-valent cation depleted solution to produce a desalinated effluent and a salt-concentrated solution;
applying an electric potential difference across the salt-concentrated solution to produce a regenerating solution; and
regenerating the ion exchange media with the regenerating solution.

12. The method according to claim 10, wherein the regenerating solution is an acid solution.

13. The method according to claim 10, further comprising diverting a portion of the feed water to be treated around the ion exchange device.

14. The method according to claim 10, further comprising diverting a portion of the salt-concentrated solution away from the bipolar electrodialysis device.

15. The method according to claim 10, further comprising diverting a portion of the acid solution away from the ion exchange device.

16. The method according to claim 10, wherein the cations are calcium cations, barium cations, strontium cations, iron cations, manganese cations, magnesium cations, or any combination thereof.
